(19) United States
(12) Patent Application Publication
(10) Pub. No.: US 2018/0107087 A1
(43) Pub. Date: Apr. 19, 2018

(54) LENS GRATING AND 3D DISPLAY

(71) Applicant: Wuhan China Star Optoelectronics Technology Co., Ltd., Wuhan, Hubei (CN)

(72) Inventor: Chang XIE, Shenzhen, Guangdong (CN)

(73) Assignee: Wuhan China Star Optoelectronics Technology Co., Ltd., Wuhan, Hubei (CN)

(21) Appl. No.: 15/112,383

(22) PCT Filed: Jun. 22, 2016
(86) PCT No.: PCT/CN2016/086716

§ 371 Date: Jul. 18, 2016

(30) Foreign Application Priority Data
May 26, 2016 (CN) 201610355582.4

(51) Int. Cl. G02F 1/29; G02F 1/1335

(52) U.S. Cl. CPC G02F 1/29; G02F 1/133526; G02F 2201/122; G02F 2201/121; G02F 2201/123; H04N 13/0413

(57) ABSTRACT

A lens grating including a first substrate and a second substrate which are disposed oppositely; a first electrode layer disposed on the first substrate; a second electrode layer disposed on the second substrate; a liquid crystal layer clamped between the first electrode layer and the second electrode layer; wherein, the first electrode layer includes multiple annular electrodes, and projections of the multiple annular electrodes are not overlapped with each other. Adopting concentric annular pixel electrodes can generate an electric field having more directions between the common electrode and the pixel electrode such that liquid crystal molecules have multiple deflection angles. Because the deflection angles of the liquid crystal molecules are increased, beneficial for a multi-domains display and expanding the viewing angle of a 3D display, enhance the display effect of an image. The 3D display of the present invention has larger viewing angle, and enhance the display effect.

### CROSS REFERENCE

The claims of this application have submitted to the State Intellectual Property Office of the People's Republic of China (SIPO) on May 26, 2016, Application No. 201610355582.4. The priority right based on the China application has a title of “Lens grating and 3D display”. The entire contents of the above-mentioned patent application will be incorporated in the present application through citing.

### FIELD OF THE INVENTION

The present invention relates to a liquid crystal display technology field, and more particularly to a lens grating and a 3D display.

### BACKGROUND OF THE INVENTION

The conventional liquid crystal display module generally includes an array substrate and a color filter substrate which are disposed oppositely, a liquid crystal layer disposed between the array substrate and the color filter substrate, a common electrode, a pixel electrode and polarizing films respectively located at the array substrate and the color filter substrate.

The display principle of the conventional liquid crystal display module is through the polarizing film of the array substrate to convert a natural light to a linearly polarized light, applying a voltage on the pixel electrode and the common electrode at two sides of the liquid crystal layer in order to form an electric field. Liquid crystal molecules in the liquid crystal layer generate a rotation under the function of the electric field so as to change a polarization state of the linearly polarized light. In the conventional art, the shape of the pixel electrode is generally strip-shaped and multiple pixel electrodes are arranged in an equal spacing such that the direction of the electric field generated between the common electrode and the pixel electrode is simpler such that the deflection angles of the liquid crystal molecules are the same. Accordingly, the viewing angle of the liquid crystal display module is smaller, and the display effect of an image is poor.

### SUMMARY OF THE INVENTION

The purpose of the present invention is to provide a lens grating, and the lens grating can solve the problems of smaller viewing angle of the liquid crystal display module, and poor display effect of an image.

Another purpose of the present invention is to provide a 3D display adopting the above lens grating.

In order to realize the above purpose, the embodiment of the present invention provides a following technology solution:

The present invention provides a lens grating, comprising: a first substrate and a second substrate which are disposed oppositely; a first electrode layer disposed on the first substrate; a second electrode layer disposed on the second substrate; a liquid crystal layer clamped between the first electrode layer and the second electrode layer; wherein, the first electrode layer includes multiple annular electrodes, and projections of the multiple annular electrodes are not overlapped with each other.

Wherein, the multiple annular electrodes are disposed concentrically.

Wherein, for adjacent two concentric annular electrodes, a radius difference value between a radius of an inner ring of the annular electrode closed to an outer side and a radius of an outer ring of the annular electrode closed to an inner side is gradually decreased from a center to an outside.

Wherein, a radius difference value between a radius of an inner ring of the annular electrode closed to an outer side and a radius of an outer ring of the annular electrode closed to an inner side is in a range from 1 micrometer to 10 micrometers.

Wherein, a radius difference value between a radius of an inner ring of the annular electrode closed to an outer side and a radius of an outer ring of the annular electrode closed to an inner side is in a range from 1 micrometer to 10 micrometers.

Wherein, the first electrode layer is a common electrode layer, and the second electrode layer is a pixel electrode layer.

Wherein, the first electrode layer is a pixel electrode layer, and the second electrode layer is a common electrode layer.

The present invention also provides a 3D display, including a lens grating, and the lens grating comprises: a first substrate and a second substrate which are disposed oppositely; a first electrode layer disposed on the first substrate; a second electrode layer disposed on the second substrate; a liquid crystal layer clamped between the first electrode layer and the second electrode layer; wherein, the first electrode layer includes multiple annular electrodes, and projections of the multiple annular electrodes are not overlapped with each other.

Wherein, the multiple annular electrodes are disposed concentrically.

Wherein, for adjacent two concentric annular electrodes, a radius difference value between a radius of an inner ring of the annular electrode closed to an outer side and a radius of an outer ring of the annular electrode closed to an inner side is gradually decreased from a center to an outside.

Wherein, a radius difference value between a radius of an inner ring of the annular electrode closed to an outer side and a radius of an outer ring of the annular electrode closed to an inner side is in a range from 1 micrometer to 10 micrometers.

Wherein, a radius difference value between a radius of an inner ring of the annular electrode closed to an outer side and a radius of an outer ring of the annular electrode closed to an inner side is in a range from 1 micrometer to 10 micrometers.

Wherein, the first electrode layer is a common electrode layer, and the second electrode layer is a pixel electrode layer.

Wherein, the first electrode layer is a pixel electrode layer, and the second electrode layer is a common electrode layer.

The embodiment of the present invention has following advantages or beneficial effects:

The first electrode layer of the lens grating of the present invention includes multiple concentric annular electrodes, adopting concentric annular pixel electrodes can generate an electric field having more directions between the common electrode and the pixel electrode such that liquid crystal molecules have multiple deflection angles. Because the deflection angles of the liquid crystal molecules are increased, beneficial for a multi-domains display and expanding the viewing angle of a 3D display, enhance the display effect of an image. The 3D display of the present invention has larger viewing angle, and enhance the display effect.

### BRIEF DESCRIPTION OF THE DRAWINGS

In order to more clearly illustrate the technical solution in the present invention or in the prior art, the following will illustrate the figures used for describing the embodiments or the prior art. It is obvious that the following figures are only some embodiments of the present invention. For the person of ordinary skill in the art without creative effort, it can also obtain other figures according to these figures.

FIG. 1 is a schematic diagram of a 3D display of the present invention;

FIG. 2 is a schematic diagram of a lens grating of the 3D display shown in FIG. 1;

FIG. 3 is a schematic diagram of a first electrode layer of the lens grating shown in FIG. 2; and

FIG. 4 is a schematic diagram of an optical path when a voltage is applied on the electrode layers of the lens grating.

### DETAILED DESCRIPTION OF THE PREFERRED EMBODIMENT

The following content combines with the drawings and the embodiment for describing the present invention in detail. It is obvious that the following embodiments are only some embodiments of the present invention. For the person of ordinary skill in the art without creative effort, the other embodiments obtained thereby are still covered by the present invention.

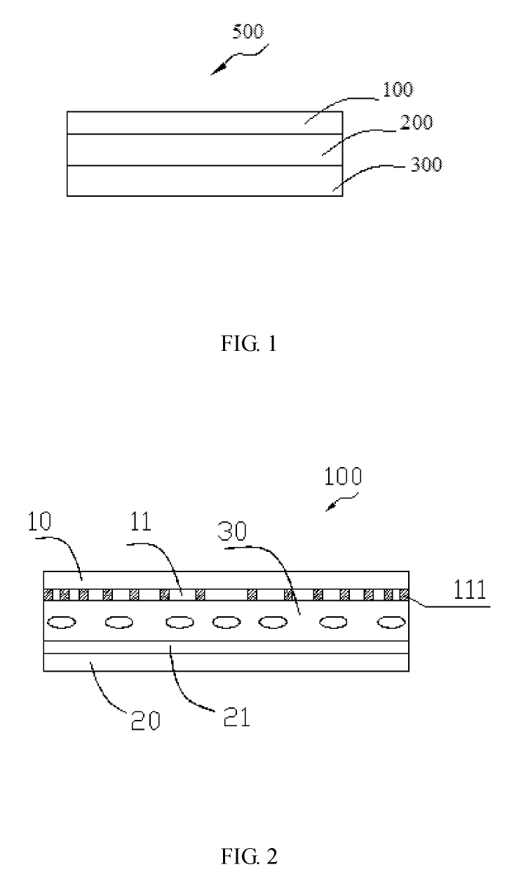

With reference to FIG. 1, in one embodiment of the present invention, a 3D display 500 includes a lens grating 100, a liquid crystal display panel 200 and a backlight source 300 which are disposed sequentially and are stacked. With reference to FIG. 2 the lens grating 100 includes a first substrate 10, a first electrode layer 11, a liquid crystal layer 30, a second electrode layer 21 and a second substrate 20. Wherein, the first substrate 10 and the second substrate 20 are disposed oppositely. Specifically, the material of each of the first substrate 10 and the second substrate 20 can be glass or other transparent materials.

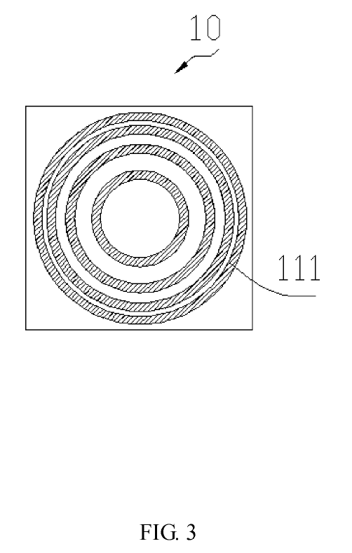

The first electrode layer 11 is located on a side of the first substrate 10 closed to the second substrate 20. The second electrode layer 21 is located at a side of the second substrate 20 closed to the first substrate 10. The liquid crystal layer 30 is clamped between the first electrode layer 11 and the second electrode layer 21. Specifically, with reference to FIG. 3, the first electrode layer 11 includes multiple annular electrodes 111. The multiple annular electrodes 111 are enclosed and stacked. That is, in the multiple annular electrodes 111, a large annular electrode surrounds a small annular electrode at an outside, and projections of the multiple annular electrodes 111 on the first substrate are not overlapped. Preferably, the multiple annular electrodes are disposed concentrically.

In the specific embodiment of the present invention, the first substrate 10 is a color filter substrate, the first electrode layer 11 is a common electrode layer, the second substrate 20 is an array substrate, and the second electrode layer 21 is a pixel electrode layer.

In the conventional art, directions of the electric field generated between the common electrode layer and the pixel electrode layer is simpler such that the liquid crystal molecules cannot rotate along multiple directions. In the present invention, the 3D display device adopts multiple annular electrodes (common electrode) in the first electrode layer of the lens grating. Through adopting concentric annular common electrodes, the electric field between the common electrode and the pixel electrode can generate more directions such that the liquid crystal molecules will have multiple deflection angles (360 degrees). Because the deflection angels of the liquid crystal molecules are increased, the present invention is more beneficial for realizing a multi-domain display and expanding the viewing angle of the 3D display device so as to enhance the display effect of the image.

Preferably, with reference to FIG. 3, for adjacent two concentric annular electrodes 111, a radius difference value between a radius of an inner ring of the annular electrode 111 closed to an outer side and a radius of an outer ring of the annular electrode 111 closed to an inner side is gradually decreased from a center to an outside. It can be understood that the radius difference value can be regarded as a spacing between adjacent two concentric annular electrodes 111. In other words, a density of the common electrodes in a center region of the common electrode layer is smaller, and a density of the common electrodes in a periphery region of the common electrode layer is greater. When spacings of adjacent common electrodes are not equal, electric field strength generated by the annular electrodes are different in order to obtain the electric field having more directions so as to beneficial for the liquid crystal molecules to deflect at more directions in order to further expand the viewing angle.

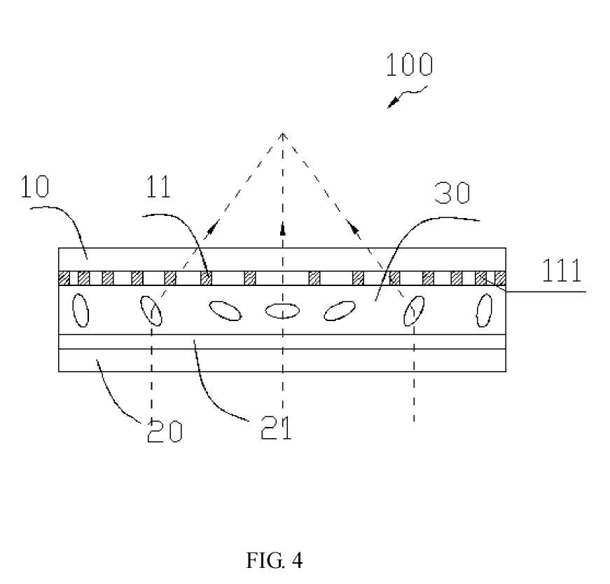

Specifically, with reference to FIG. 2, when the first electrode layer 11 and the second electrode layer 21 is not applied with a voltage, the liquid crystal layer 30 is under a horizontal alignment state such that when a light pass through the liquid crystal layer which is arranged evenly, an optical focus will not be generated. At this time, the display is under a 2D-display mode. With reference to FIG. 4, when the first electrode layer 11 and the second electrode layer 21 are applied with a voltage, the liquid crystal molecules in the liquid crystal layer 30 are under an action of the force of an electric field, and the liquid crystal molecules gradually stand up. Because the common electrode layer 21 adopts an annular electrode design, a spacing density of the common electrodes in the center region is different from a spacing density of the common electrodes in the periphery region. A spacing between adjacent electrodes at the periphery region is smaller, a vertical force of the electric field is stronger such that the liquid crystal molecules stand up at a greater degree. A spacing between adjacent electrodes at the center region is larger, a vertical force of the electric field is weaker such that the liquid crystal molecules stand up at a smaller degree. Accordingly, the liquid crystal molecules present a gradually changing state from a horizontal arrangement to a vertical arrangement and from the center region to the periphery region.

The light (shown as dashed lines in FIG. 3) generates an optical focus through the gradually changing liquid crystal layer. At this time, the display is under a 3D-display mode. Besides, in the lens grating of the present invention, because the common electrode adopts an unequal spacing annular electrode design, no matter viewing from up, down, left or right or an oblique angle, the display can all present wide-viewing angles, expanding the range of viewing angle of the 3D effect and increase a 3D stereoscopic display effect.

It can be understood that width of each concentric annular electrodes can be set according to a requirement. When the number of the concentric annular electrodes is more, the adjusting of the present invention is more precise, and the improvement effect for a far view or a closed view is better.

Besides, when the spacing between common electrodes is too small, electric fields of adjacent common electrodes will generate interference. When the spacing between common electrodes is too large, the strength of the electric fields of the common electrodes is not enough such that the liquid crystal molecules will not be deflected. Accordingly, a reasonable electrode spacing is required. Preferably, for adjacent two concentric annular electrodes, a radius difference value between a radius of an inner ring of the annular electrode closed to an outer side and a radius of an outer ring of the annular electrode closed to an inner side is in a range from 1 micrometer to 10 micrometers.

In another embodiment, the structure of the lens gating can also be: a pixel electrode layer on the array substrate includes multiple concentric annular electrodes 111, and the multiple concentric annular electrodes 111 are not overlapped with each other. The common electrode layer on the color filter substrate is a conventional common electrode layer, and the above effect can also be achieved. That is, the first substrate 10 is an array substrate, the first electrode layer 11 is a pixel electrode layer, the second substrate 20 is a color filter substrate, and the second electrode layer 21 is a common electrode layer.

It can be understood that the 3D display 500 provided by the present invention can be applied in any product or part of the electronic paper, LCD TVs, mobile phones, digital photo frame, table having a display function.

In the description of the present invention, the reference term “one embodiment”, “some embodiments”, “example”, “specific example” or “some examples” and so on means specific features, structures and materials combined in the embodiment or example, or the characteristic being included in at least one embodiment or example. In the description of the present invention, the schematically description of the above terms not certainly indicate a same embodiment or example. Besides, the described specific feature, structure, material, or characteristic can be combined by a suitable way in anyone or multiple embodiments or examples.

The above embodiment does not constitute a limitation of the scope of protection of the present technology solution. Any modifications, equivalent replacements and improvements based on the spirit and principles of the above embodiments should also be included in the protection scope of the present technology solution.

What is claimed is:

1. A lens grating, comprising:
a first substrate and a second substrate which are disposed oppositely;
a first electrode layer disposed on the first substrate;
a second electrode layer disposed on the second substrate;
a liquid crystal layer clamped between the first electrode layer and the second electrode layer;
wherein, the first electrode layer includes multiple annular electrodes, and projections of the multiple annular electrodes are not overlapped with each other.

2. The lens grating according to claim 1, wherein, the multiple annular electrodes are disposed concentrically.

3. The lens grating according to claim 2, wherein, for adjacent two concentric annular electrodes, a radius difference value between a radius of an inner ring of the annular electrode closed to an outer side and a radius of an outer ring of the annular electrode closed to an inner side is gradually decreased from a center to an outside.

4. The lens grating according to claim 3, wherein, a radius difference value between a radius of an inner ring of the annular electrode closed to an outer side and a radius of an outer ring of the annular electrode closed to an inner side is in a range from 1 micrometer to 10 micrometers.

5. The lens grating according to claim 1, wherein, a radius difference value between a radius of an inner ring of the annular electrode closed to an outer side and a radius of an outer ring of the annular electrode closed to an inner side is in a range from 1 micrometer to 10 micrometers.

6. The lens grating according to claim 1, wherein, the first electrode layer is a common electrode layer, and the second electrode layer is a pixel electrode layer.

7. The lens grating according to claim 1, wherein, the first electrode layer is a pixel electrode layer, and the second electrode layer is a common electrode layer.

8. A 3D display, comprising a lens grating, a liquid crystal display panel and a backlight source, and the lens grating comprises:
a first substrate and a second substrate which are disposed oppositely;
a first electrode layer disposed on the first substrate;
a second electrode layer disposed on the second substrate;
a liquid crystal layer clamped between the first electrode layer and the second electrode layer;
wherein, the first electrode layer includes multiple annular electrodes, and projections of the multiple annular electrodes are not overlapped with each other.

9. The 3D display according to claim 8, wherein, the multiple annular electrodes are disposed concentrically.

10. The 3D display according to claim 8, wherein, for adjacent two concentric annular electrodes, a radius difference value between a radius of an inner ring of the annular electrode closed to an outer side and a radius of an outer ring of the annular electrode closed to an inner side is gradually decreased from a center to an outside.

11. The 3D display according to claim 10, wherein, a radius difference value between a radius of an inner ring of the annular electrode closed to an outer side and a radius of an outer ring of the annular electrode closed to an inner side is in a range from 1 micrometer to 10 micrometers.

12. The 3D display according to claim 8, wherein, a radius difference value between a radius of an inner ring of the annular electrode closed to an outer side and a radius of an outer ring of the annular electrode closed to an inner side is in a range from 1 micrometer to 10 micrometers.

13. The 3D display according to claim 8, wherein, the first electrode layer is a common electrode layer, and the second electrode layer is a pixel electrode layer.

14. The 3D display according to claim 8, wherein, the first electrode layer is a pixel electrode layer, and the second electrode layer is a common electrode layer.
